(19) United States
(12) Patent Application Publication
(10) Pub. No.: US 2011/0307215 A1
(43) Pub. Date: Dec. 15, 2011

(54) Distance Detection System, Method Thereof and Hand-Held Electronic Device

(75) Inventor: Li-Qun Xu, Nanjing (CN)

(73) Assignees: INVENTEC APPLIANCES (SHANGHAI) CO., LTD., Shanghai (CN); INVENTEC APPLIANCES CORP., NANJING, Nanjing (CN); INVENTEC APPLIANCES CORP., New Taipei City (TW)

(21) Appl. No.: 13/150,503

(22) Filed: Jun. 1, 2011

(30) Foreign Application Priority Data
Jun. 11, 2010 (CN) 201010200857X

(51) Int. Cl. G06F 15/00; G01B 21/16

(52) U.S. Cl. 702/159

(57) ABSTRACT

A distance detection system and method for use in a hand-held electronic device is described. The distance detection system comprises an input unit used to input at least one instruction; at least one processing device having a timing element and a calculating element; at least one signal device; and an air inspecting unit. The signal device is used to transmit a signal to a detecting object in response to the instruction, and to receive a response signal from the detecting object. The timing element is used to measure an interval between transmitting the signal and receiving the response signal. The air inspecting unit is used to detect a condition of air between the hand-held electronic device and the detecting object. The data of the detected air condition can be converted into a parameter to calculate distance data corresponding to a distance from both the parameter and the measured interval.

### BACKGROUND OF THE INVENTION

1. Field of the Invention

The present invention relates to a detection system and a method thereof, and more particularly to a distance detection system, a method thereof and a hand-held electronic device having a function of detecting a distance from a detecting object.

2. Description of Related Art

Thanks to the development of technologies, present hand-held electronic devices such as mobile phones come with diversified functions. Mobile phones are developed from an early stage with simple functions of dialing and receiving calls to smart phones with powerful functions. In addition to the functions of alarm clock, notepad, calculator, calendar and editor, present mobile phones can also act as a video recorder, a camera, a game player, an answering machine, and a video player. What is more, they can be connected to networks for watching television and even be used as a navigation device. The mobile phones with various kinds of functions are similar to a portable computer with a mobile secretary.

At present, most mobile phones primarily have reinforced functions to those mentioned above, but it is not easy to add more fancy functions to the existing diversified functions. To provide better daily application and convenience, mobile phone manufacturers still commit to develop new functions to the mobile phones, and it definitely takes much effort and goes through lots of trouble to add functions applicable to mobile phones and in compliance with user's requirements.

In some mobile phones available in the market, a detection function is developed and implemented, wherein the mobile phone is used for range detections. There are two main range detection methods, respectively: a long-distance detection that determines the distance between a user and another position coordinate by using satellite positioning signals, and is generally used for detecting a rough distance between two locations since it has a larger error; and a short-distance detection that measures the distance of a nearby object, and is generally used for high-precision applications with a smaller error tolerance.

For present existing mobile phones, the short-distance detection technology usually applies sound wave or microwave to determine a distance by a method similar to sonar detection. However, factors such as suspended particle concentration in the air or humidity vary constantly, so that the propagation velocity of sound waves or microwaves in air is affected significantly by different media, and the precision of the short-distance detection cannot be improved, and thus the short-distance range detection function is not widely accepted. As the precision of the short-distance detection has substantial value to the function of the mobile phones, the precise short-distance detection can be a stand-alone function, or developed to a user remote-control mode by means of the precise range detection to provide more convenience to users. Therefore, finding a way to improve the precision of the short-distance range detection of a palm electronic device or a mobile phone demands immediate attentions and feasible solutions.

### SUMMARY OF THE INVENTION

In view of the foregoing drawbacks of the prior art, it is a primary purpose of the present invention to provide a distance detection system and a distance detection method for use in a hand-held electronic device, and a hand-held electronic device having a function of detecting a distance from a detecting object to overcome a poor precision of a short-distance detection.

An objective of the present invention is to provide a distance detection system for use in a hand-held electronic device, and the distance detection system comprises an input unit, at least one processing device, at least one signal device, and an air inspecting unit. The input unit is used to input at least one instruction. The at least one processing device has a timing element and a calculating element. The at least one signal device is coupled to the processing device. The signal device is to be activated to transmit a signal to a detecting object in response to the instruction, and is to then receive a response signal reflected from the detecting object. The timing element is to be activated to measure an interval between transmitting the signal from the signal device and receiving the response signal by the signal device. The air inspecting unit is coupled to the processing device, and is to be activated to detect a condition of air between the hand-held electronic device and the detecting object. And data of the detected air condition can be converted by the distance detection system into a parameter for the calculating element to calculate distance data from both the parameter and the measured interval, wherein the distance data corresponds to a distance. The distance detection system may further comprise a display unit used to display the distance according to the distance data. The display unit may be of the hand-held electronic device.

In one embodiment, the at least one signal device comprises a transmitting device and a receiving device. The transmitting device is to be activated to transmit the signal to the detecting object, while the timing element is activated to measure time. The receiving device is used to receive the response signal. And the reception of the response signal then causes the timing element to stop the time measurement and the timing element is then to record the measured interval.

Also in one embodiment, interval measurement by the timing element is stopped if the response signal for a predetermined period has not been received by the signal device, the display unit is then activated to display an error message based on an error detection signal. In addition, operation of the signal device and the air inspecting unit may be stopped based on the error detection signal.

The air inspecting unit of the distance detection system may comprise an air sensor used to detect the air condition. The air condition may concern suspended particulates' concentration or humidity of the air. The signal transmitted by the signal device may be a microwave having an electromagnetic spectrum between those of a radio wave and an infrared light, between 300 MHz and 300 GHz, or between a wavelength of 10⁻² cm and a wavelength of 10² cm, but the present invention is not limited to such limitations only. And the parameter may concern a transmission speed of the signal under the air condition.

Also in one embodiment, the calculating element is used to calculate distance data from both the parameter and the measured interval by employing a mathematical program or algorithm.

Another objective of the present invention is to provide a distance detection method for use in a hand-held electronic device, and the distance detection method comprises the following steps: inputting at least one instruction to the hand-held electronic device; transmitting a signal from the hand-held electronic device to a detecting object in response to the instruction; the hand-held electronic device receiving a response signal reflected from the detecting object; measuring an interval between transmitting the signal from the hand-held electronic device and receiving the response signal by the hand-held electronic device; detecting a condition of air between the hand-held electronic device and the detecting object; and converting data of the detected air condition into a parameter to calculate distance data from both the parameter and the measured interval, wherein the distance data corresponds to a distance. In addition, another step of displaying the distance according to the distance data may be included.

The distance detection method may further comprise a step of recording the measured interval when the step of measuring the interval is stopped upon the hand-held electronic device receiving the response signal.

The distance detection method also may further comprise steps of: stopping measuring the interval if for a predetermined period, the response signal has not been received by the hand-held electronic device; and displaying an error message based on an error detection signal.

Another object of the present invention is to provide a hand-held electronic device having a function of detecting a distance from a detecting object, and the hand-held electronic device comprises an input unit, at least one processing device, at least one signal device, an air inspecting unit, and a display unit. The input unit is used to input at least one instruction. The at least one processing device has a timing element and a calculating element. The at least one signal device is coupled to the processing device. The signal device is to be activated to transmit a signal to a detecting object in response to the instruction, and is to then receive a response signal reflected from the detecting object. The timing element is to be activated to measure an interval between transmitting the signal from the signal device and receiving the response signal by the signal device. The air inspecting unit is coupled to the processing device, and is to be activated to detect a condition of air between the hand-held electronic device and the detecting object. Data of the detected air condition can be converted by the distance detection system into a parameter for the calculating element to calculate distance data from both the parameter and the measured interval. And the display unit is used to display a distance according to the distance data.

In summary, the distance detection system, the method thereof, and the hand-held electronic device having a function of detecting a distance from a detecting object have one or more of the following advantages. The parameter described above may concern a transmission speed of the signal under the air condition, and the distance data may be calculated from both the parameter and the measured interval by employing a mathematical program or algorithm, resulting in the distance data being more accurate.

### BRIEF DESCRIPTION OF THE DRAWINGS

FIG. 1 shows a block diagram of a distance detection system for use in a hand-held electronic device according to an embodiment of the present invention;

FIG. 2 shows a flow chart of a distance detection method for use in a hand-held electronic device according to an embodiment of the present invention;

FIG. 3 shows a first schematic view of detecting a distance by using a distance detection system according to an embodiment of the present invention; and

FIG. 4 shows a second schematic view of detecting a distance by using a distance detection system according to an embodiment of the present invention.

### DETAILED DESCRIPTION OF THE PREFERRED EMBODIMENTS

In broad summary, the distance detection system of the present invention for use in a hand-held electronic device comprises an input unit, at least one processing device, at least one signal device coupled to the processing device, and an air inspecting unit coupled to the processing device. The input unit is used to input at least one instruction. The at least one processing device has a timing element and a calculating element, encompassing the possibility that the processing device include the timing element and the calculating element. The signal device is to be activated to transmit a signal to a detecting object in response to the instruction, and is to then receive a response signal reflected from the detecting object, and the timing element is to be activated to measure an interval between transmitting the signal from the signal device and receiving the response signal by the signal device. With respect to the detecting object, the distance detection system is used to detect a distance of/from the detecting object, or a distance from the distance detection system or the hand-held electronic device to the detecting object. Moreover, the air inspecting unit is to be activated to detect a condition of air between the hand-held electronic device and the detecting object. And data of the detected air condition can be or is to be converted by the distance detection system into a parameter for the calculating element to calculate distance data from both the parameter and the measured interval, wherein the distance data corresponds to the distance to be detected. In addition, the term “hand-held electronic device” is used here to encompass a wide range of mobile or portable electronic devices, as flexibly decided by one of ordinary skill in the art employing the invention.

It's noted that a display unit used to display the distance according to the distance data may be included in or with the distance detection system. In one embodiment, according to circumstances and requirements, the distance detection system may include the display unit separated from the hand-held electronic device. In other embodiments, as when the hand-held electronic device includes the distance detection system, the display unit may belong to the hand-held electronic device or the distance detection system. Arrangement of the hand-held electronic device, the distance detection system, and the display unit can be flexibly designed by one of ordinary skill in the arts respectively of electronic and mobile devices to meet various purposes and requirements. Alternatively, the distance detection system can even be a hand-held electronic device having a function of detecting a distance of/from a detecting object, wherein the hand-held electronic device includes a regular display unit which may also be used to display the distance according to the distance data. What follows is description of some embodiments of the present invention. The embodiments are described herein for illustrative purposes only and should not improperly limit the scope of the invention as defined by the appended claims.

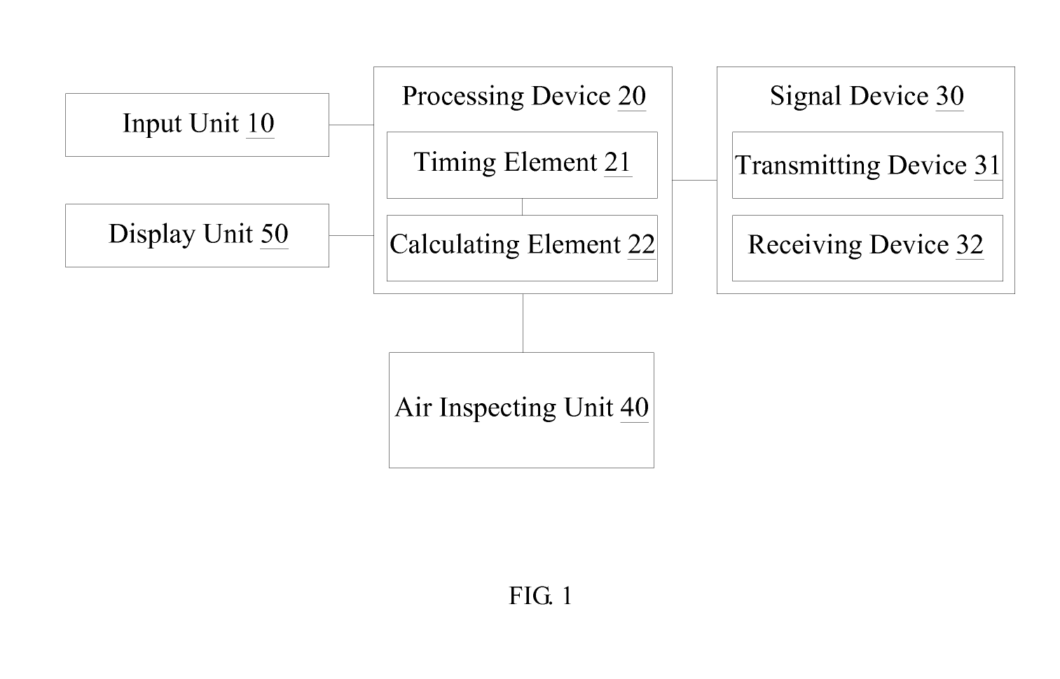

FIG. 1 shows a block diagram of a distance detection system for use in a hand-held electronic device according to an embodiment of the present invention. With reference to FIG. 1, the distance detection system for use in a hand-held electronic device (not shown) comprises an input unit 10, at least one processing device 20, at least one signal device 30 coupled to the processing device 20, and an air inspecting unit 40 coupled to the processing device 20. The input unit 10 is coupled to the processing device 20, which has a timing element 21 and a calculating element 22. The processing device 20 is coupled to the signal device 30, the air inspecting unit 40 and a display unit 50. The signal device 30 further comprises a transmitting device 31 and a receiving device 32.

The input unit 10 is used e.g. by users to input at least one instruction to the distance detection system. In response to the instruction, the processing device 20 activates the transmitting device 31 of the signal device 30 to transmit a signal to a detecting object (not shown in the figure). With respect to the detecting object, the distance detection system is used to detect a distance of/from the detecting object, or a distance from the distance detection system or the hand-held electronic device to the detecting object. Then, the receiving device 32 is used to receive a response signal reflected from the detecting object. In this embodiment, while the transmitting device 31 of the signal device 30 is activated to transmit the signal, the processing device 20 activates the timing element 21 to measure an interval between the transmitting device 31 transmitting the signal and the receiving device 32 receiving the response signal reflected from the detecting object. And the reception of the response signal by the receiving device 32 then causes the timing element 21 to stop the time measurement, wherein the timing element 21 is then to record the measured interval.

In this embodiment, the processing device 20 activates the air inspecting unit 40 to detect a condition of air between the hand-held electronic device and the detecting object, and data of the detected air condition can be or is to be converted by the distance detection system or the processing device 20 into a parameter for the calculating element 22 to calculate distance data which corresponds to a distance as between the hand-held electronic device and the detecting object. The calculating element 22 then calculates the distance data from both the parameter and the measured interval, and then the processing device 20 may drive the display unit 50 to display the distance according to the distance data.

In this embodiment, if for a predetermined period the response signal has not been received by the signal device 30, interval measurement by the timing element 21 is stopped, and then an error detection signal, such as an error detection instruction, may be produced by e.g. the receiving device 32 and transmitted to the processing device 20, such that the processing device 20 activates the display unit 50 to display an error message based on the error detection signal. Then operation of the signal device 30 and the air inspecting unit 40 may be stopped based on the error detection signal.

The air inspecting unit 40 of this embodiment comprises an air sensor used to detect the air condition. The air condition concerns e.g. suspended particulates' concentration or humidity of the air. In this embodiment, the signal is a microwave having an electromagnetic spectrum between those of a radio wave and an infrared light, between 300 MHz to 300 GHz, or between a wavelength of 10⁻² cm and a wavelength of 10² cm. But the present invention is not limited to such detailed limitations.

The invention also provides a distance detection method for use in a hand-held electronic device, the method comprising the steps: inputting at least one instruction to the hand-held electronic device; transmitting a signal from the hand-held electronic device to a detecting object in response to the instruction, or the hand-held electronic device transmitting a signal to a detecting object in response to the instruction; the hand-held electronic device receiving a response signal reflected from the detecting object; measuring an interval between transmitting the signal from the hand-held electronic device and receiving the response signal by the hand-held electronic device; detecting a condition of air between the hand-held electronic device and the detecting object; and converting data of the detected air condition into a parameter to calculate distance data from both the parameter and the measured interval, wherein the distance data corresponds to a distance.

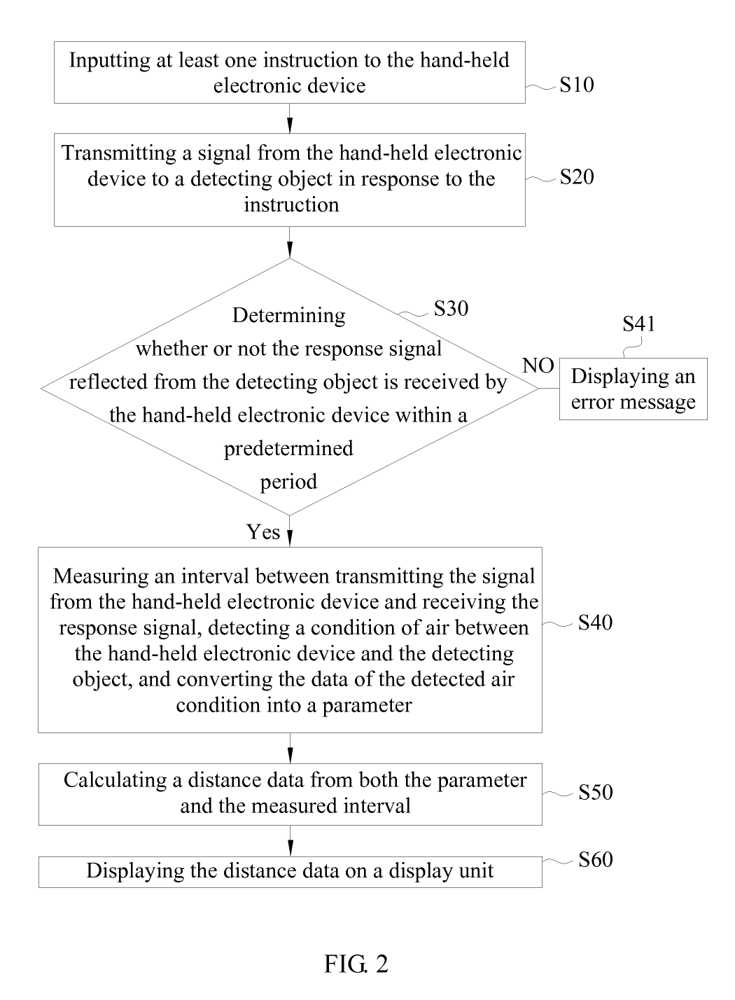

With reference to FIG. 2 for a flow chart of the distance detection method for use in a hand-held electronic device (not shown) according to an embodiment of the present invention, the applied distance detection method in the embodiment proceeds as follows:

S10: Inputting at least one instruction to the hand-held electronic device. This step may be performed through the input unit 10.

S20: Transmitting, e.g. by the signal device 30, a signal from the hand-held electronic device to a detecting object in response to the instruction. The signal may be a microwave having an electromagnetic spectrum between those of a radio wave and an infrared light, between 300 MHz and 300 GHz, or between a wavelength of 10⁻² cm and a wavelength of 10² cm.

S30: Determining whether or not the response signal reflected from the detecting object is received by the hand-held electronic device within a predetermined period. If it's determined that the response signal is received within the predetermined period, the applied method proceeds to steps in S40.

S40: Measuring, e.g. by the timing element 21, an interval between transmitting the signal from the hand-held electronic device and receiving the response signal by the hand-held electronic device, and then detecting, e.g. by the air inspecting unit 40, a condition of air between the hand-held electronic device and the detecting object, and then converting, e.g. by the processing device 20, the data of the detected air condition into a parameter. It's noted that the air condition may concern suspended particulates' concentration or humidity of the air. And the parameter may concern a transmission speed of the signal under the air condition.

S50: Calculating distance data from both the parameter and the measured interval, wherein the distance data corresponds to a distance, as between the hand-held electronic device and the detecting object. This step of calculating may be performed by the calculating element 22 and/or by employing a mathematical program or algorithm.

S60: Displaying the distance data on a display unit. If a display unit used to display the distance according to the distance data is available, this step may be performed.

If it's determined that the response signal is not received within the predetermined period, the applied method proceeds from S30 to S41, where the interval measurement may be stopped and then an error message may be displayed based on an error detection signal. And it's noted that the steps at S41 and S60 both can mark an end of an instance of applying this method.

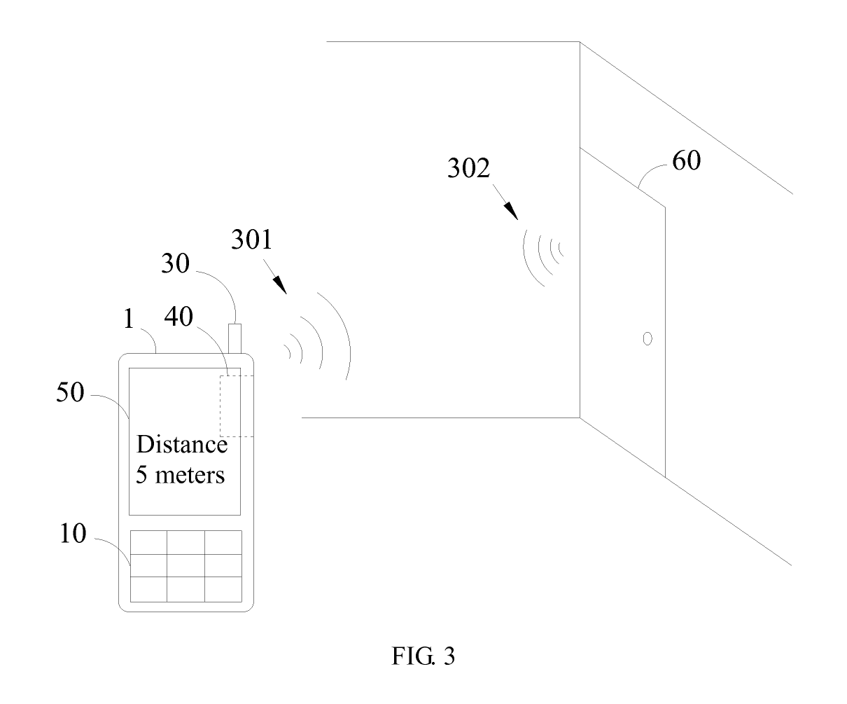

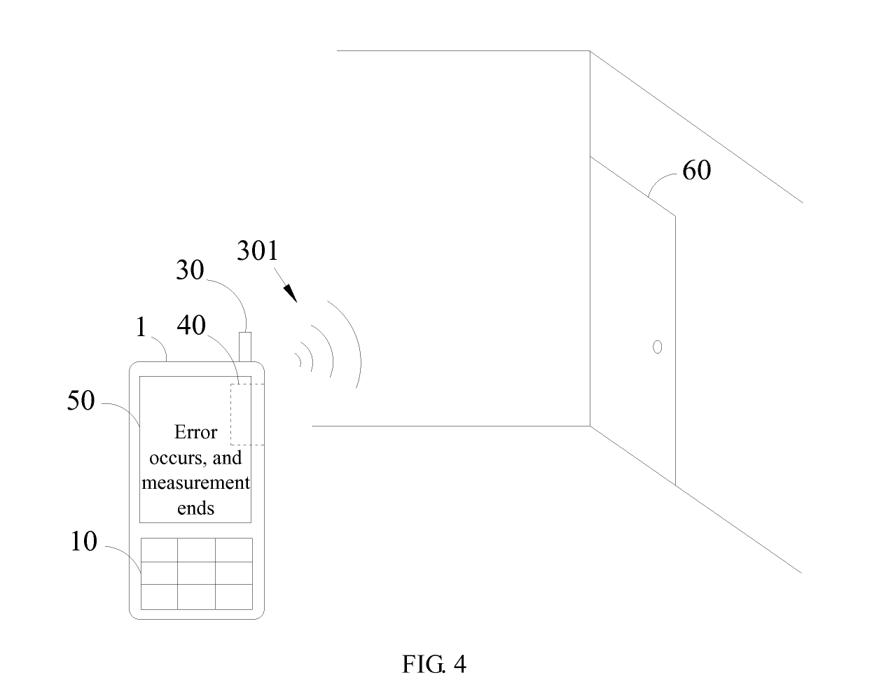

FIG. 3 and FIG. 4 show respectively first and second schematic views of detecting a distance by using a distance detection system according to embodiments of the present invention. As shown in FIG. 3 and FIG. 4, the hand-held electronic device 1 of a preferred embodiment comprises an input unit 10, a signal device 30, an air inspecting unit 40, a display unit 50, and a processing device (not shown in the figure), and the distance detection system of the invention is used in the hand-held electronic device 1 to detect the distance of/from the detecting object 60. The arrangement and function of the units and devices included in the hand-held electronic device 1 in this embodiment of the present invention can be the same as those described above for embodiments of the distance detection system, and therefore not described here again. In this preferred embodiment, the hand-held electronic device 1 is shown as a mobile phone, and the detecting object 60 is shown as a door, and the distance between the detecting object 60 and the hand-held electronic device 1 is equal to 5 m, but the present invention is not limited to such detailed limitations.

The distance detection method may further comprise a step of recording the measured interval when the step of measuring the interval is stopped upon the hand-held electronic device receiving the response signal. Then the air inspecting unit 40 may be activated to detect the air condition for obtaining the parameter. Therefore in this embodiment the distance between the hand-held electronic device 1 and the detecting object 60 is detected and measured to be equal to 5 m, and the detected distance is displayed on the display unit 50 (as shown in FIG. 3), but the invention is not limited to such detailed limitations.

As described above, if the waiting time for receiving the response signal 302 is equal to or greater than a predetermined period, the display unit 50 will display an error message based on an error detection signal and end the distance detection for this time. And operation of the signal device 30 and the air inspecting unit 40 may be stopped based on the error detection signal. In this preferred embodiment, the error message displayed by the display unit 50 shows “Error occurs, and measurement ends” (as shown in FIG. 4), but the invention is not limited to such detailed limitations.

While the invention has been described by means of specific embodiments, numerous modifications and variations could be made thereto by those skilled in the art without departing from the scope and spirit of the invention set forth in the claims.

What is claimed is:

1. A distance detection system for use in a hand-held electronic device, comprising:
an input unit used to input at least one instruction;
at least one processing device having a timing element and a calculating element;
at least one signal device coupled to the processing device, wherein the signal device is to be activated to transmit a signal to a detecting object in response to the instruction, and is to then receive a response signal reflected from the detecting object, and the timing element is to be activated to measure an interval between transmitting the signal from the signal device and receiving the response signal by the signal device; and
an air inspecting unit coupled to the processing device, wherein the air inspecting unit is to be activated to detect a condition of air between the hand-held electronic device and the detecting object, wherein data of the detected air condition is able to be converted by the distance detection system into a parameter for the calculating element to calculate distance data from both the parameter and the measured interval, wherein the distance data corresponds to a distance.

2. The distance detection system of claim 1, wherein the at least one signal device comprises:
a transmitting device to be activated to transmit the signal to the detecting object, while the timing element is activated to measure time; and
a receiving device used to receive the response signal, wherein the reception of the response signal then causes the timing element to stop the time measurement, wherein the timing element is then to record the measured interval.

3. The distance detection system of claim 1, wherein a display unit of the hand-held electronic device is used to display the distance according to the distance data.

4. The distance detection system of claim 1, wherein interval measurement by the timing element is stopped if for a predetermined period the response signal has not been received by the signal device, and a display unit for displaying a distance according to the distance data is then activated to display an error message based on an error detection signal.

5. The distance detection system of claim 4, wherein operation of the signal device and the air inspecting unit is stopped based on the error detection signal.

6. The distance detection system of claim 1, wherein the air inspecting unit comprises an air sensor used to detect the air condition.

7. The distance detection system of claim 1, wherein the air condition concerns suspended particulates' concentration or humidity of the air.

8. The distance detection system of claim 1, wherein the signal is a microwave having an electromagnetic spectrum between those of a radio wave and an infrared light, between 300 MHz and 300 GHz, or between a wavelength of 10⁻² cm and a wavelength of 10² cm.

9. The distance detection system of claim 1, wherein the parameter concerns a transmission speed of the signal under the air condition.

10. The distance detection system of claim 1, wherein the calculating element is used to calculate distance data from both the parameter and the measured interval by employing a mathematical program or algorithm.

11. A distance detection method for use in a hand-held electronic device, comprising the steps of:
inputting at least one instruction to the hand-held electronic device;
transmitting a signal from the hand-held electronic device to a detecting object in response to the instruction;
the hand-held electronic device receiving a response signal reflected from the detecting object;
measuring an interval between transmitting the signal from the hand-held electronic device and receiving the response signal by the hand-held electronic device;
detecting a condition of air between the hand-held electronic device and the detecting object; and
converting data of the detected air condition into a parameter to calculate distance data from both the parameter and the measured interval, wherein the distance data corresponds to a distance.

12. The distance detection method of claim 11, further comprising a step of recording the measured interval when the step of measuring the interval is stopped upon the hand-held electronic device receiving the response signal.

13. The distance detection method of claim 11, further comprising the following steps:
stopping measuring the interval if for a predetermined period the response signal has not been received by the hand-held electronic device; and
displaying an error message based on an error detection signal.

14. The distance detection method of claim 11 wherein the air condition concerns suspended particulates' concentration or humidity of the air.

15. The distance detection method of claim 11, wherein the parameter concerns a transmission speed of the signal under the air condition.

16. The distance detection method of claim 11, wherein the distance data is calculated from both the parameter and the measured interval by employing a mathematical program or algorithm.

17. A hand-held electronic device having a function of detecting a distance from a detecting object, the hand-held electronic device comprising:
an input unit used to input at least one instruction;
at least one processing device having a timing element and a calculating element;
at least one signal device coupled to the processing device, wherein the signal device is to be activated to transmit a signal to a detecting object in response to the instruction, and is to then receive a response signal reflected from the detecting object, and the timing element is to be activated to measure an interval between transmitting the signal from the signal device and receiving the response signal by the signal device;
an air inspecting unit coupled to the processing device, wherein the air inspecting unit is to be activated to detect a condition of air between the hand-held electronic device and the detecting object, wherein data of the detected air condition is able to be converted by the distance detection system into a parameter for the calculating element to calculate distance data from both the parameter and the measured interval; and
a display unit used to display a distance according to the distance data.

18. The hand-held electronic device of claim 17, wherein the at least one signal device comprises:
a transmitting device to be activated to transmit the signal to the detecting object, while the timing element is activated to measure time; and
a receiving device used to receive the response signal, wherein the reception of the response signal then causes the timing element to stop the time measurement, wherein the timing element is then to record the measured interval.

19. The hand-held electronic device of claim 17, wherein interval measurement by the timing element is stopped if for a predetermined period the response signal has not been received by the signal device, and the display unit is then activated to display an error message based on an error detection signal.

20. The hand-held electronic device of claim 19, wherein operation of the signal device and the air inspecting unit is stopped based on the error detection signal.
